(19) United States
(12) Patent Application Publication
(10) Pub. No.: US 2004/0204977 A1
(43) Pub. Date: Oct. 14, 2004

(54) System and method for automated consumables and maintenance parts replacement

(76) Inventor: James E. Obert, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/409,726

(22) Filed: Apr. 9, 2003

(51) Int. Cl. G06F 17/60

(52) U.S. Cl. 705/8

(57) ABSTRACT

The present invention provides for servicing a device by receiving a service request signal from a serviced device, the service request signal corresponding to a need for service to the serviced device and having an identifier which identifies the serviced device; identifying a service agreement that is applicable to the serviced device based upon the received identifier; retrieving entitlement information corresponding to the service agreement, the entitlement information defining at least one attribute of service that is to be provided under the service agreement, and the attribute of service corresponding to the need for service; determining a response specifying a service that corresponds to the need for service; communicating a message to an entity with instructions to provide the service; and receiving a service completed signal from the serviced device, the service completed signal corresponding to a condition indicating that the need for service has been provided.

### TECHNICAL FIELD

The present invention is generally related to maintaining operation of an apparatus and, more particularly, is related to a system and method for automated replenishment of consumables, replacement of maintenance components and/or repair of failed components in an electrical device.

### BACKGROUND

It is desirable to automatically effect replenishment of consumables and/or replacement of maintenance parts. For example, a printing device consumes ink, toner or the like as the printing device prints information on a sheet of paper. Such information may include text, images and/or data printed in one or more colors. Ink, toner or the like is provided to the printing device in a predefined, bulk amount so that many sheets of paper may be printed before the ink, toner or the like is eventually consumed. Once the ink, toner or the like is consumed, operation of the printing device is halted (printing operation is halted) until the ink, toner or the like is replenished. Accordingly, the ink, toner or the like is defined herein as a “consumable” for convenience.

The printing device may use a variety of other consumables that must be periodically replenished. For example, paper might be considered a consumable. Furthermore, consumables are applicable to other types of electrical devices. Automated teller machines also use ink, toner or the like when receipts are prepared. However, the cash supply or the supply of blank receipt paper may also be considered as a consumable in some situations. Kiosks, registers, ticket machines, . . . are other non-limiting examples of electrical devices that use consumables.

Furthermore, such electrical devices may have components that should be periodically replaced to ensure reliable, safe and/or continues operation of the electrical device. For example, print heads in an ink jet printer could be a replaceable component based upon hours of use, amount of ink consumed, number of pages printed or the like. A component that is replaceable on a periodic basis is defined herein as a “maintenance component” for convenience. Thus, one characteristic of a maintenance component is that the timing of the replacement can be predicted. For example, the hours of use, amount of ink consumed, number of pages printed or the like can be used to predict the need for replacing the maintenance component. Furthermore, some maintenance components may easily be replaced by the user or another non-technical individual having a minimum degree of training in the replacement of the component. Or, a qualified service technician may be required to replace the maintenance component.

Additionally, components of the electrical device may fail in an unexpected manner. Accordingly, a technician may be required to provide service to the electrical device to replace the failed component and or effect other related repairs. Since such component failures occur in an unpredictable manner, service is provided on a reactionary basis.

Often, the process of replenishing consumables, replacing maintenance components and/or repairing failed components is specified under an agreement, contract or the like. That is, the user of the electrical device contracts with a service provider to provide for the replenishment of consumables, replacing of maintenance components and/or repairing of failed components. Such an agreement, contract or the like is defined herein as a “service agreement” for convenience.

Typically, the service agreement specifies a variety of parameters under which the service is provided. For example, one service agreement may provide for replenishment with premium quality consumables, such as a special ink provided by the manufacturer of the electrical device. Alternatively, another service agreement may provide for replenishment with lower grade, less costly consumables, such as a generic ink. For convenience, the attributes that specify the nature of the service provided pursuant to a service agreement are defined herein as “entitlements.” Thus, in the simplified example above, the entitlements under the service agreement define the nature of the replenished consumable (whether the consumable should be replaced with the premium grade ink or the generic ink).

The service agreement may also specify other parameters, such as, but not limited to, costs charged for services and/or response times for providing a service after upon notification from the user. Thus, if a component fails, one service contract may specify an entitlement corresponding to a quick response time, such as several hours or overnight. Another service contract may specify a different entitlement corresponding to a slower response time, such as one or more days.

When a service provider is providing service to a plurality of different customers, wherein each customer has one or more electrical devices, and providing service under a variety of different service agreements each having unique entitlements, the task of determining an appropriate response for a particular device becomes a very complex task. Furthermore, determining an appropriate response becomes even more complex when a single user has a plurality of electrical devices each having different device-specific entitlements under the service contract. For example, the user may have a printing device that is to be replenished with premium ink and have another printing device that is to be replenished with generic ink.

Upon receiving a service request to replenish a consumable, replace a maintenance component, or repair a failed component, the entitlements under the service contract between the user and the service provider must be determined. Then, an appropriate response can be formulated. For example, when the ink is consumed, the entitlement may specify that a premium replacement ink is to be expressed mailed or even hand-delivered to the electrical device. In another example, the entitlement may specify regular postal mailing of the generic ink to the address where the electrical device is located. In yet another example, the entitlement may specify that it is not the responsibility of the service provider to provide replacement ink. Thus, the appropriate response formulated for a particular electrical device may be unique for that electrical device.

Once entitlements have been defined by the service agreement, the appropriate response is implemented. However, determining the appropriate response is a time consuming effort that is subject to errors or mistakes, especially if the process is manual. In the simplified illustrative example above, the entitlement may require that the service provider immediately dispatch personnel to the location of the electrical device and replenish the device with premium ink. On the other hand, the entitlement may require the service provide to merely place an order with a third party vendor with instructions to the vendor to mail the generic ink to the location of the electrical device.

Errors or mistakes in providing the appropriate response according to the entitlements as defined under the service agreement can be very costly. For example, if the entitlement provides for mailing generic ink, the added cost of hand-delivering premium ink may not be recoverable under the service agreement. Likewise, failing to provide the entitlement, such as mailing generic ink when hand-delivery of premium ink is specified, may result in unrecoverable costs to remedy the substandard performance and/or may result in penalty costs to the service provider.

Therefore, it is very desirable to provide a correct response to a service request, as defined by the entitlements under the service agreement, in a cost effective manner. Many of the above-described examples may be manually implemented by employees of the service provider. Automation of some tasks in the above described examples may be more cost efficient. Furthermore, confirmation that the replenishment of consumables and/or replacement of maintenance components was effected as specified by the entitlements under the service agreement is desirable.

### SUMMARY

The present invention provides a system and method for automated program updating in a remote device. Briefly described, in architecture, one embodiment is a system which provides service to a serviced device, comprising an interface configured to receive a service request signal and a service completed signal generated by a serviced device via a communication system communicatively coupling the serviced device and the order management system (OMS), the received service request signal and the service completed signal including an identifier that identifies the serviced device; a user database configured to provide information pertaining to a user of the serviced device, configured to provide information pertaining to the serviced device, and configured to provide information identifying a service agreement corresponding to the serviced device; an entitlement and service agreement (ESA) database, the EAS database configured to provide information pertaining to at least one entitlement provided under the service agreement, the entitlement defining a service to be performed in response to the received service request message; a message database configured to provide a first message template such that a first message corresponding to the service request signal is generated, and configured to provide a second message template such that a second message corresponding to the service completed signal is generated; and a processor configured to generate the first message and configured to cause the first message to be communicated to at least a first party such that the service corresponding to the service request signal is provided to the serviced device, and further configured to cause the second message to be communicated to at least a second party corresponding to the service completed signal so that the second party understands that the service has been completed.

Another embodiment comprises method for servicing a device comprising receiving a service request signal from a serviced device, the service request signal corresponding to a need for service to the serviced device and having an identifier which identifies the serviced device; identifying a service agreement that is applicable to the serviced device based upon the received identifier; retrieving entitlement information corresponding to the service agreement, the entitlement information defining at least one attribute of service that is to be provided under the service agreement, and the attribute of service corresponding to the need for service; determining a response specifying a service that corresponds to the need for service; communicating a message to an entity with instructions to provide the service; and receiving a service completed signal from the serviced device, the service completed signal corresponding to a condition indicating that the need for service has been provided.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention.

FIG. 1 is a block diagram illustrating one embodiment of an order management system (OMS) in accordance with the present invention coupled to a plurality of serviced devices.

FIG. 2 is a block diagram illustrating in greater detail an embodiment of an OMS.

FIG. 3 is a flowchart illustrating a process, according to the present invention, for servicing a serviced device by embodiments of the OMS.

### DETAILED DESCRIPTION

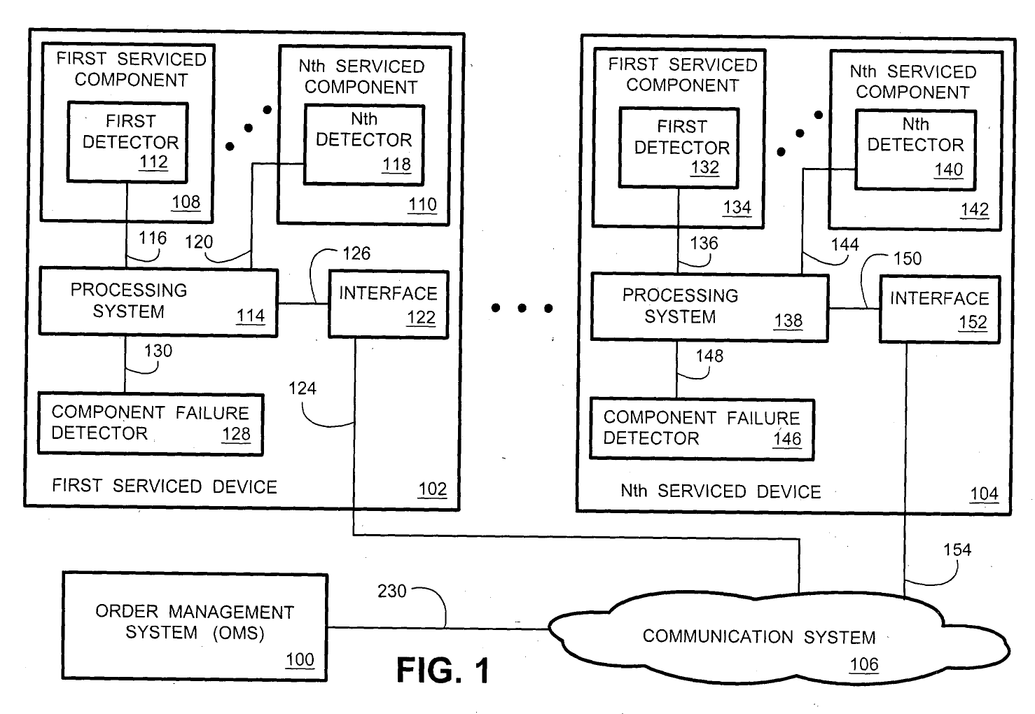

FIG. 1 is a block diagram illustrating one embodiment of a order management system (OMS) 100 in accordance with the present invention coupled to a plurality of serviced devices 102, 104. OMS 100 is coupled to the plurality of serviced devices 102, 104 via communication system 106.

For convenience, communication system 106 is illustrated and described as a simplified communication system that is, in reality, a very complex communication system. For example, communication system 106 may be the known telephony system that employs both analog and digital forms of communication. Or the communication system 106 may be the Internet. Furthermore, the communication system 106 may be a hybrid system comprised of interacting portions of multiple different types of communication systems. For example, communication system 106 may be a combination of a telephony system and the Internet. Other illustrative communication systems include RF wireless systems, satellite systems and/or cable systems. It is appreciated that the nature of the communication system 106, with respect to the present invention as described in detail herein, is relevant only to the extent that any particular embodiment is configured to provide communications in a format that is compatible with the type of communication system 106 that is being utilized by that embodiment.

Each of the serviced devices 102, 104 include at least one serviced component that may be replenished or replaced under a service agreement between the user of the serviced device and a service provider. The nature of the service provided under the service agreement is specified by an entitlement corresponding to each serviced component.

For convenience, the serviced device 102 is illustrated as having a first serviced component 108 and an Nth serviced component 110. Thus, it is understood that the first serviced device 102 may have a plurality of serviced components. However, it is also understood that a serviced device may have only one serviced component.

A first detector 112 resides in, or is coupled to, the first serviced component 108. The first detector 112 is configured to communicate a signal to processing system 114, via connection 116, that indicates that the first serviced component 108 needs a service. The generation of the need for service signal occurs when there is a need for service. Alternatively, signals indicating a status of the first serviced component 108 may be periodically communicated to the processing system 114. Similarly, the Nth serviced component 110 includes an Nth detector 118 configured to communicate a need for service signal to processing system 114, via connection 120, that indicates that the Nth serviced component 110 requires service.

The first serviced device includes an interface 122 that is configured to communicatively couple the first serviced device 102 to the communication system 106, via connection 124. Accordingly, when a need for service signal is received by the processing system 114 from any of the detectors 112, 118, a service request can be generated by the processing system 114. This service request is communicated to the interface 122, via connection 126, for further communication to the OMS 100, via the communication system 106.

A simplified illustrative example is provided to demonstrate how a service request is generated by the processing system 114. Assuming the first serviced device 102 is a printer and the first serviced component 108 is the supply of toner, ink or the like, the first detector 112 is configured to sense (or detect) when the level of toner, ink or the like decreases down to a predefined threshold. That is, as information is printed onto a paper or other suitable medium by the first serviced device 102 (a printer in this illustrative example), the supply of toner, ink or the like decreases as the toner, ink or the like is consumed by the printing process. Accordingly, it is understood that the toner, ink or the like is a “consumable” as defined in accordance with the present invention.

Once the supply of toner, ink or the like decreases to the predefined threshold, a need for service signal is communicated to the processing system 114 indicating that the consumable (toner, ink or the like) has decreased to the predefined threshold. Accordingly, it is understood that it is time to initiate an action to replenish the consumable in a timely manner so that operation of the first serviced device 102 (a printer in this illustrative example) may continue in an uninterrupted manner. When such a need for service signal is received by the processing system 114, processing system 114 generates a service request signal that is communicated to the OMS 100. As will be described in greater detail hereinbelow, embodiments of the OMS 100 will effect a response to provide a replenishment of the consumable (toner, ink or the like in this illustrative example).

The predefined threshold may be any suitable value that corresponds to the supply of the consumable wherein it becomes desirable to replenish the consumable. This threshold, in some embodiments, is an adjustable value that can be adjusted based upon the entitlement as defined by the service agreement associated with the serviced device. For example, in one embodiment, the entitlement may provide for mailing of a generic toner, ink or the like. Based upon a predictive use of the serviced device 102 (a printer in this illustrative example) and the time required to provide the replenishment consumable, a time can be predicted that allows sufficient time for ordering the consumable by the OMS 100, time for mailing, and time for replenishment. Accordingly, a first threshold can be determined based upon the above-described factors. In another situation, the entitlement may require immediate or overnight replenishment of the consumable. Thus, the predictive use of the serviced device 102 and the nature of the entitlement (a printer in this illustrative example) allows determination of a different threshold for that device (which may be expected to be less than the above-described first threshold, given less time for replenishment of the consumable and given similar predictive use of the printer).

Continuing with this simplified, illustrative example, the Nth serviced component 110 may be a component that requires periodic replacement to ensure reliable, safe and/or continues operation of the first serviced device 102. For convenience, such a component is referred to herein as a maintenance component. The Nth detector is configured to sense, monitor or otherwise determine the usage of the Nth serviced component. When the service life reaches a predetermined threshold, a need for service signal is communicated by the Nth detector 118 to the processing system 114. Processing system 114 generates a service request signal that is communicated to the OMS 100. As will be described in greater detail hereinbelow, embodiments of the OMS 100 will effect a response to provide a replacement component in a timely manner.

Furthermore, one or more component failure detectors 128 may be disposed within the first service device to detect an unexpected failure of a component. When such a failure is detected, component failure detector 128 communicates a need for service signal, via connection 130, to the processing system 114 such that processing system 114 generates a service request signal that is communicated to the OMS 100. Here, because the component has failed, the first serviced device 102 has likely ceased or halted operation in an undesirable. Operation cannot be resumed until the failed component is repaired or replaced. Accordingly, the OMS 100 initiates a response, in accordance with an entitlement under a service agreement, to cause a repair technician, and/or a repair component, to be dispatched to the first serviced device 102 so that the repair can be effected.

The Nth serviced device 104 may be similarly configured as the above-described first serviced device 102. Thus, the Nth serviced device 104 is illustrated as having a first detector 132 residing in or coupled to a first serviced component 134. If, for example, the first detector 132 is monitoring or detecting supply of a consumable, when supply of a consumable decreases to a predefined threshold, a need for service signal is communicated by the first detector 132, via connection 136, to the processing system 138 indicating a need for servicing, such as when a consumable needs to be replenished.

The Nth serviced device 104 is further illustrated as having an Nth detector 140 residing in or coupled to an Nth serviced component 142. If, for example, the Nth detector 140 is monitoring or detecting service life of a maintenance component, when the service life of the maintenance component decreases to a predefined threshold, a signal is communicated by the Nth detector 140, via connection 144, to the processing system 138 indicating a need for servicing (replacing the maintenance component).

The Nth serviced device 104 is further illustrated as having a component failure detector 146 disposed within the Nth service device 104 to detect an unexpected failure of a component. When such a failure is detected, component failure detector 146 communicates a signal, via connection 148, to the processing system 138.

When a need for service signal generated by the first detector 132, Nth detector 140 and/or component failure detector 146 and is communicated to processing system 138, processing system 138 generates a service request signal that is communicated to the OMS 100, via connection 150, interface 152 and connection 154. The communication of the service request signal via connection 150, interface 152 and connection 154 may be the same as or similar to the above-described process wherein a service request signal generated by processing system 114 is communicated to the OMS 100 via connection 126, interface 122 and connection 124.

Detectors 112, 118, 128, 132, 140 and 146 were described above as being configured to detect a condition such that a signal is communicated to its respective processing system 114, 138 so that a service request signal can be generated and communicated to the OMS 100. The detectors 112, 118, 128, 132, 140 and 146, in one embodiment, are further configured to monitor or detect a change in condition that indicates that the need for service has been resolved. In one embodiment, one or more of the detectors 112, 118, 128, 132, 140 and 146 continuously monitor the condition. In other embodiments, one or more of the detectors 112, 118, 128, 132, 140 and 146 periodically monitor the condition.

Once a change of condition is detected, the monitoring detector 112, 118, 128, 132, 140 and 146 communicates a second signal to its respective processing system 114, 138. Upon receiving the second signal, the processing system 114, 138 generates and communicates another signal or the like, referred to for convenience as a “service completed signal,” to the OMS 100 to indicate that service has been effected. It is understood that any suitable formatted signal can be generated and communicated that indicates that the previously communicated service request has been resolved.

For example, with respect to the above-described simplified example, if the first detector 112 is monitoring the supply of a consumable such as ink, toner or the like, the first detector 112 sends the second signal to processing system 114 when the consumable is replenished. When this second signal is received, the processing system 138 communicates the service completed signal to the OMS 100. Accordingly, the OMS 100 can process the received service completed signal as described in greater detail hereinbelow.

Similarly, if the Nth detector 118 is monitoring use of a component that requires periodic maintenance replacement, the Nth detector 118 sends the second signal to processing system 114 when the component is replaced. Likewise, if the component failure detector 128 has previously detected a component failure, the component failure detector 128 sends the second signal to processing system 114 when the failed component has been repaired and/or replaced. When this second signal is received, the processing system 138 communicates the service completed signal to the OMS 100 for further processing as described in greater detail hereinbelow.

Interfaces 122 and 152 provide connectivity between its respective serviced device 102, 104 and communication system 106. Interfaces 122, 152 may be any suitable device that provides such connectivity, depending upon the nature of the communication system 106 that it is coupled to. Non-limiting examples of interfaces 122, 152 include interfaces to a standard telephony system, a frame relay based system, in internet or intranet, a local access network (LAN), an Ethernet, a cable system, a radio frequency (RF) system, a cellular system, an infrared system or the like. Furthermore, intermediate devices may be employed to provide connectivity all of the way to the OMS 100. For example, if interface 122 is configured to transmit the service request signal and the service completed signal in a RF format, intermediate devices may be employed which convert the received signals to a format that is further communicated through the communication system 106 to OMS 100. It is understood that embodiments of the present invention are not limited by the nature of the interfaces 122, 152.

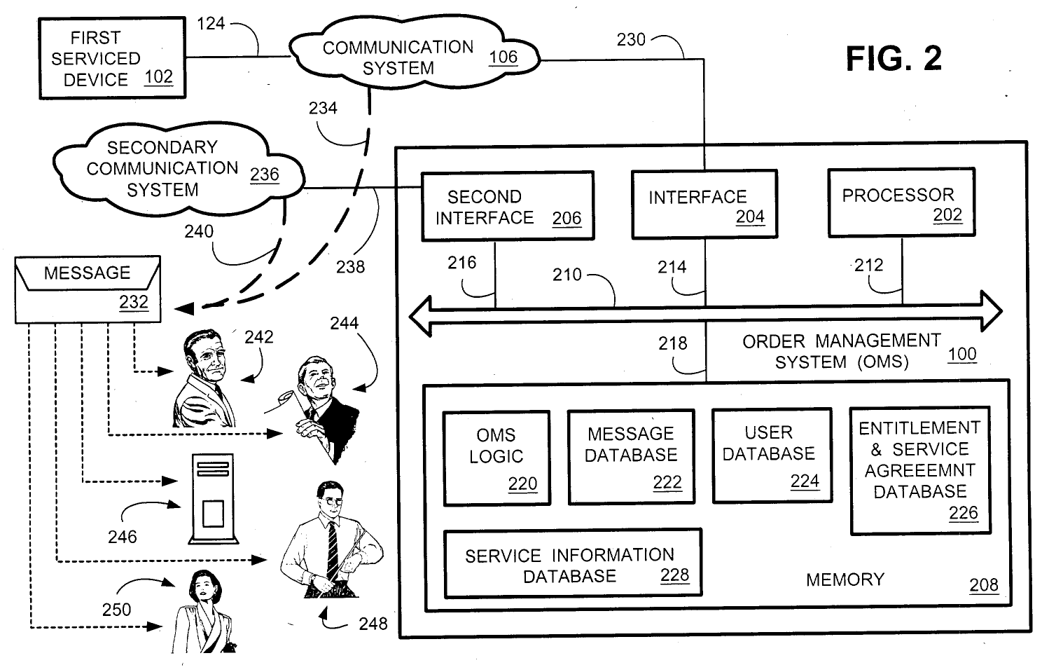

FIG. 2 is a block diagram illustrating in greater detail an embodiment of an order management system (OMS) 100. For convenience, only the first serviced device 102 is illustrated. Is it understood that the communication system 106 is coupled to a plurality of serviced devices, and accordingly, OMS 100 receives service request signals and service completed signals from those plurality of serviced devices.

The OMS 100 includes a processor 202, a first interface 204, an optional second interface 206 and a memory 208. Processor 202, first interface 204, second interface 206 and memory 208 are communicatively coupled through communications bus 210, via connections 212, 214, 216 and 218 respectively, thereby providing connectivity between the above-described components. In alternative embodiments of an OMS 100, the above-described components are connectivley coupled in a different manner than illustrated in FIG. 2. For example, one or more of the above-described components may be directly coupled to each other or may be coupled to each other via intermediary components (not shown).

One embodiment of memory 208 further includes the OMS logic 220, an optional message database 222, a user database 224, an entitlement and service agreement database 226 and an optional service information database 228. OMS logic 100, described in greater detail below, the resides as firmware, software or other computer-readable medium executed by processor 202.

OMS 100 is coupled to the communication system 106, via connection 230, through the first interface 204. Thus, a service request signal or a service completed signal communicated from a serviced device is received by the first interface 204 and is processed into a format that is communicated to the processor 202. Processor 202, while executing the OMS logic 220, can then process the received communication to determine the nature of the received service request signal or service completed signal.

Processing of a received service request signal or service completed signal includes identifying the sending serviced device. Accordingly, the received service request signal or service completed signal includes any suitable identifier that identifies the sending serviced device. This identifier is used to enable the processor 202 to access data regarding the serviced device that resides in the user database 224 and the entitlement and service agreement database 226.

In one embodiment, the identifier is used by the processor 202 to identify the attributes of the serviced device, such as, but not limited to, the type of serviced device, the manufacturer or model number of the serviced device, and/or the physical location of the serviced device. The user of the serviced device, such as a name of a contact person employed by the user, is also identifiable. Also, an identifier of the service agreement may be provided so that entitlement information relating to the service agreement can be retrieved.

The identifier is further used to enable the processor 202 to retrieve information relating to the service agreement, and the associated entitlements, that applies to the serviced device. Accordingly, it is understood that the identifier in the received service request signal or service completed signal allows the processor 202, executing the OMS logic 220, to correlate information in the user database 224 and the entitlement and service agreement database 226 with the identifier such that a particular response to the received service request signal or service completed signal can be determined. Thus, if a service request signal is communicated that indicates a need for service such as replenishment of a consumable, the information allows the processor 202 to ascertain which consumable is to be replenished. Similarly, if a service request signal indicates a response such as replacement of a maintenance component, or repair of a failed component, the processor 202 is able to ascertain specifics regarding the needed service.

In the above-described simplified example wherein the first detector monitors supply of a consumable used by the first serviced device 102, a received service request message that includes the above-described information enables the processor 202, executing the OMS logic 220, to determine that the consumable used by the first serviced device 102 needs to be replenished in accordance with the service agreement between the user and the service provider. Thus, the appropriate response is determinable. For example, one exemplary response, under an entitlement, is that the consumable is to be replenished with a generic consumable and be provided by regular surface postal service. In another example, the entitlement is used to determine that the response is that the consumable is to be immediately replaced with a high grade consumable, and that a service technician or the like should be dispatched to replenish the consumable.

After the specific service required has been determined, OMS 100 initiates performance of the service specified in the response. This initiation may come in a variety of forms, depending upon the specific task(s) required to perform the specified service. For example, if a determined response specifies that a consumable is to be mailed to the location of the serviced device initiating the service request signal, then OMS 100 communicates a message 232 corresponding to an order for the consumable with a selling agent with instructions that the consumable is to be mailed to the location of the serviced device. If the response specifies that replacement of a maintenance part or a failed part is needed, then OMS 100 communicates a message 232 corresponding to an order for the part with a selling agent. The OMS may further communicates a message 232 which instructs that the part to be sent to the location of the serviced device, such as when the user can change out the part or when a technician or other specially qualified individual will be sent to the location to replace the part. Or, the OMS may communicate a message 232 to have the part sent directly to the technician or other specially qualified individual to ensure that the part is available before dispatching the technician or other specially qualified individual to the location of the serviced device.

If a technician or other specially qualified individual is required to replenish the consumable, replace a maintenance component, or replace a failed component, then the OMS100 further communicates a message 232 with a dispatcher at a call center or the like, or other person responsible for scheduling work flow of the technician or other specially qualified individual.

Ordering of consumables or parts by the OMS 100 from the selling agent, and/or requesting that a technician or other specially qualified individual be dispatched by the dispatcher, is implemented by a message 232. Such orders, also referred to herein as a “message” 232 for convenience, may be made as an electronic communication. Examples of a message 232 include e-mails, electronic orders, voice messages or any other suitable communication. The message 232 may be communicated directly to a person, such as a selling agent employee 242 or the dispatcher 244, using a form of communication that is recognizable by the receiving person. Alternatively, the message 232 may be communicated directly to another electronic system 246, such as, but not limited to, an electronic order processing device, that is configured to electronically receive orders for consumables, parts or service from the OMS 100.

Message database 222, in one embodiment, includes a plurality of pre-formatted message “message templates” that are selected based upon the intended recipient and the nature of the information that is to be included in the message 232. Thus, if a message 232 is to be communicated to the user indicating that a consumable has been replenished under an entitlement defined by the service agreement, the appropriate pre-formatted message template is retrieved, and the “blanks” of the message template are conveniently filed in with relevant information. The “blanks” may include such relevant information as a serviced device identifier, attributers of the replenished consumable, information identifying the user such as an address, name and/or service agreement number, and other information that is of interest. Accordingly, it is understood that there is no intended limit to the number, types or nature of the pre-formatted message templates, or the types of relevant information, that are used to construct a particular message 232.

Message 232 may be communicated from interface 204 thorough communication system 106, as illustrated by the dashed-arrow line 234. In another embodiment, message 232 is communicated from second interface 206 that is configured to facilitate communications with a secondary communication system 236, via connection 238, as illustrated by the dashed-arrow line 240. Such a secondary communication system may be a LAN, Ethernet or other suitable communication system that communicatively couples OMS 100 with the intended recipient of the message 232.

Furthermore, a plurality of messages 232 corresponding to a received service request may be communicated to a variety of recipients. For example, if a consumable is to be replenished, a message 232 is communicated to the selling agent employee 242 and/or the electronic system 246 so that the consumable is ordered, another message 232 is communicated to an account manager 248 or other interested individual who has an interest in the provided service, and/or another message 232 is communicated to the user 250 of the first serviced device. Accordingly, it is understood that embodiments of the OMS 100 can be configured to coordinate the service among a plurality of interested parties.

As described above, once service to the serviced device has been completed as specified by the response, determined from the entitlements of the service agreement, the service device communicates a service completed signal to the OMS 100 to indicate that service has been provided. OMS 100 then generates a corresponding second message 232 (or another message 232), and communicates the message 232 to interested parties. For example, the account manager 248 may want to know that service was completed so that billing to the user can be initiated. In one embodiment, OMS 100 generates and communicates a billing for the provided service to the user.

In another embodiment, a second message 232 is communicated to the user to indicate that the service was provided. The message 232 may also include other information of interest such as attributes of the service provided. Such attributes may include the date/time of the initial service request signal, date/time of the service completed signal, consumable or part provided, cost of providing the service, information relating to the attributes and/or service agreement, and/or other information of interest.

It is understood that the message 232 can be formatted to be communicated to any suitable interested party and contain any information that is of interest to the party receiving message 232. Thus, messages 232 are generated and communicated in response to a received service request signal and a received service completed signal.

Embodiments of OMS 100 may include service information database 228. Service information database 228 is configured to store information relating to the type of service provided, thereby creating a historical database of services provided to the various serviced devices. Such information is provided to the service database as the OMS 100 initiates services and/or communicates messages 232. Any suitable information of interest may be saved into the service information database 228. Other embodiments of OMS 100 communicate messages 232 to remote database device (not shown). The remote database may be part of another system, or a dedicated database device that is more conveniently implemented outside of the OMS 100.

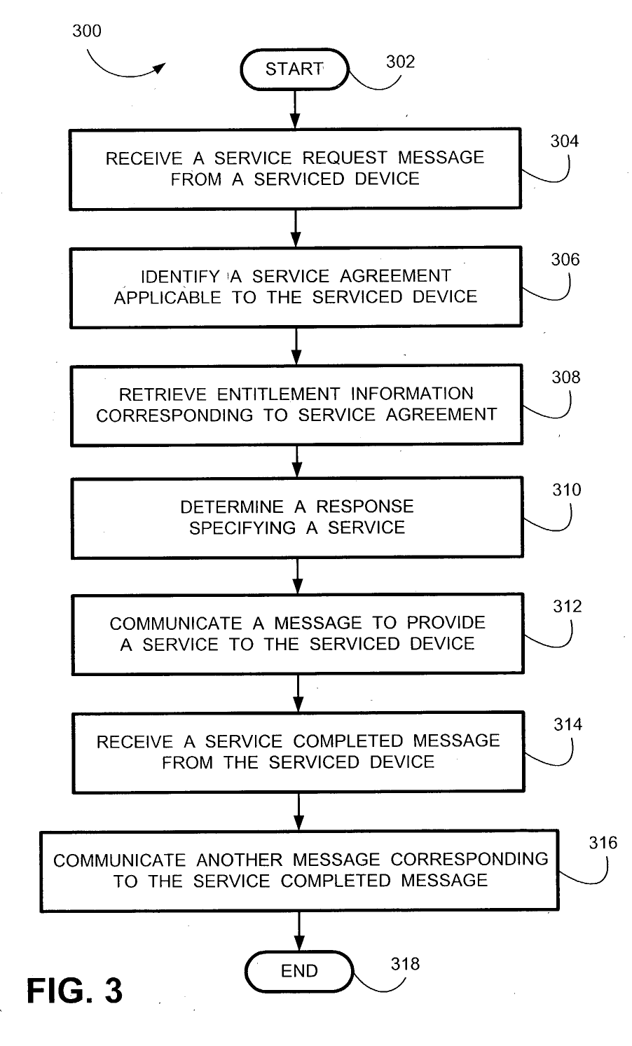

FIG. 3 is a flowchart 300 illustrating a process, according to the present invention, for servicing a serviced device by embodiments of the OMS 100 (FIGS. 1 and 2). The flow chart 300 of FIG. 3 shows the architecture, functionality, and operation of an embodiment for implementing the OMS logic 220 (FIG. 2), as described above in accordance with the present invention. An alternative embodiment implements the logic of flow chart 300 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIG. 3, or may include additional functions, without departing from the functionality of the OMS 100. For example, two blocks shown in succession in FIG. 3 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present invention

The process begins at block 302. At block 304, a service request message is received from a serviced device, the service request message corresponding to a need for service to the serviced device and having an identifier which identifies the serviced device. At block 306, a service agreement that is applicable to the serviced device is identified based upon the received identifier. At block 308, entitlement information corresponding to the service agreement is retrieved, the entitlement information defining at least one attribute of service that is to be provided under the service agreement, and the attribute of service corresponding to the need for service. At block 310, a response specifying a service that corresponds to the need for service is determined. At block 312, a message to an entity is communicated with instructions to provide a service that corresponds to the need for service. At block 314, a service completed message is received from the serviced device, the service completed message corresponding to a condition indicating that the need for service has been provided. At block 316, one embodiment further communicates another message corresponding to the received service completed message. The process ends at block 318.

Embodiments of the invention implemented in memory 208 (FIG. 2) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

It should be emphasized that the above-described embodiments of the present invention are merely examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method for servicing a device, comprising:
receiving a service request signal from a serviced device, the service request signal corresponding to a need for service to the serviced device and having an identifier which identifies the serviced device;
identifying a service agreement that is applicable to the serviced device based upon the received identifier;
retrieving entitlement information corresponding to the service agreement, the entitlement information defining at least one attribute of service that is to be provided under the service agreement, and the attribute of service corresponding to the need for service;
determining a response specifying a service that corresponds to the need for service;
communicating a message to an entity with instructions to provide the service; and
receiving a service completed signal from the serviced device, the service completed signal corresponding to a condition indicating that the need for service has been provided.

2. The method of claim 1, further comprising comparing the identifier with a user database having user information, the user information corresponding to a user of the serviced device identifying attributes of the user.

3. The method of claim 2, wherein the user information comprises at least one selected from a group consisting of a physical location of the serviced device, a type of serviced device, a manufacturer of the serviced device, a model number of the serviced device, a service agreement identifier and a name of a contact person employed by the user.

4. The method of claim 1, wherein the attribute of service comprises at least one selected from a group consisting of a consumable that is to be replenished in the serviced device, a maintenance component that is to be replaced in the serviced device and a failed component that is to be replaced in the serviced device.

5. The method of claim 1, wherein determining the response further comprises placing an order for a consumable with a service agent such that the consumable is delivered to a location of the serviced device.

6. The method of claim 1, wherein determining the response further comprises placing an order for a replacement component with a service agent such that the replacement component is delivered to a location of the serviced device.

7. The method of claim 6, wherein placing an order further comprises placing an order for a maintenance component.

8. The method of claim 6, wherein placing an order further comprises placing an order for a failed component.

9. The method of claim 1, wherein determining the response further comprises communicating another message to a dispatcher so that the dispatcher can dispatch a service technician to the location of the serviced device to perform the service.

10. The method of claim 1, wherein communicating the message to an entity with instructions to provide a service further comprises;
placing an order for a failed component with a dispatcher such that the failed component is delivered to a location of the serviced device; and
communicating another message to the dispatcher so that the dispatcher can dispatch a service technician to the location of the serviced device to perform the service.

11. The method of claim 1, further comprising communicating another message to a user of the serviced device so that the user is aware of the received service request signal.

12. The method of claim 1, further comprising communicating another message to an account manager responsible for managing the service agreement corresponding to the serviced device so that the account manager is aware of the received service request signal.

13. The method of claim 1, further comprising:
retrieving a message template;
filling out the message template with relevant information; and
generating the message based upon the message template and the relevant information.

14. The method of claim 1, further comprising communicating a second message to the entity indicating that the service has been completed, the second message corresponding to the received service completed signal.

15. The method of claim 1, further comprising communicating a second message to a user of the serviced device so that the user is aware that the service has been completed, the second message corresponding to the received service completed signal.

16. The method of claim 1, further comprising communicating another message to an account manager responsible for managing the service agreement so the account manager is aware that the service has been completed, the other message corresponding to the received service completed signal.

17. The method of claim 1, further comprising updating information in a service information database, the updated information corresponding to the received service request signal.

18. The method of claim 1, further comprising further comprising updating information in a service information database, the updated information corresponding to the received service completed signal.

19. The method of claim 1, wherein communicating the message to an entity with instructions to provide a service further comprises communicating the message to an employee of a selling agent, the selling agent responsible for providing one of a consumable, a maintenance part and a failed part.

20. The method of claim 1, wherein communicating the message to an entity with instructions to provide a service further comprises communicating the message to an electronic order processing device operated by a selling agent, the selling agent responsible or providing one of a consumable, a maintenance part and a failed part.

21. The method of claim 1, wherein receiving the service request message further comprises generating the service request signal, the service request signal generated in response to a signal from a detector corresponding to the detection of the need for service.

22. The method of claim 1, wherein receiving the service completed message further comprises generating the service completed signal, the service completed signal generated in response to a signal from a detector corresponding to the detection of a completion of service.

23. An order management system (OMS) which provides service to a serviced device, comprising:
an interface configured to receive a service request signal and a service completed signal generated by a serviced device via a communication system communicatively coupling the serviced device and the OMS, the received service request signal and the service completed signal including an identifier that identifies the serviced device;
a user database configured to provide information pertaining to a user of the serviced device, configured to provide information pertaining to the serviced device, and configured to provide information identifying a service agreement corresponding to the serviced device;
an entitlement and service agreement (ESA) database, the EAS database configured to provide information pertaining to at least one entitlement provided under the service agreement, the entitlement defining a service to be performed in response to the received service request message;
a message database configured to provide a first message template such that a first message corresponding to the service request signal is generated, and configured to provide a second message template such that a second message corresponding to the service completed signal is generated; and
a processor configured to generate the first message and configured to cause the first message to be communicated to at least a first party such that the service corresponding to the service request signal is provided to the serviced device, and further configured to cause the second message to be communicated to at least a second party corresponding to the service completed signal so that the second party understands that the service has been completed.

24. The OMS of claim 23, further comprising a service information database, the service information database configured to contain information pertaining to the service request signal, the service completed signal, and the service provided.

25. The OMS of claim 23, further comprising a second interface configured to couple the OMS to a secondary communication system such that the second message communicated to the second party is communicated over the secondary communication system.

26. A system for servicing a device, comprising:
means for receiving a service request signal from a serviced device, the service request signal corresponding to a need for service to the serviced device and having an identifier which identifies the serviced device;
means for retrieving entitlement information corresponding to a service agreement applicable to the serviced device, the entitlement information defining at least one attribute of service that is to be provided under the service agreement, and the attribute of service corresponding to the need for service;
means for determining a response, the response specifying a service that corresponds to the need for service;
means for communicating a first message to at least a first entity with instructions to provide the service;
means for receiving a service completed signal from the serviced device, the service completed signal corresponding to a condition indicating that the need for service has been provided; and
means for communicating a second message to at least a second entity so that the second entity understands that the service has been completed.

27. A computer-readable medium having a program for servicing a device, the program comprising logic configured to perform the steps of:
processing a service request signal received from a serviced device, the service request signal corresponding to a need for service to the serviced device and having an identifier which identifies the serviced device;
retrieving information corresponding to a service agreement that is applicable to the serviced device based upon the received identifier;
retrieving entitlement information corresponding to the service agreement, the entitlement information defining at least one attribute of service that is to be provided under the service agreement, and the attribute of service corresponding to the need for service;
determining a response, the response specifying a service that corresponds to the need for service;
generating a first message that is to be communicated to at least a first entity with instructions to provide the service;
processing a service completed signal received from the serviced device, the service completed signal corresponding to a condition indicating that the need for service has been provided; and
generating a second message that is to be communicated to at least a second entity so that the second entity understands that the service has been completed.
